(19) United States
(12) Patent Application Publication
(10) Pub. No.: US 2015/0375899 A1
(43) Pub. Date: Dec. 31, 2015

(54) Capture the Moment Container

(71) Applicant: Peter Bongiardino, Hewitt, NJ (US)

(72) Inventor: Peter Bongiardino, Hewitt, NJ (US)

(21) Appl. No.: 14/318,634

(22) Filed: Jun. 28, 2014

(51) Int. Cl. B65D 25/14; B65D 81/20; A47J 41/02; A44C 25/00

(52) U.S. Cl. CPC B65D 25/14; A44C 25/002; B65D 81/2015; A47J 41/02

(57) ABSTRACT

The invention is a container which may take the form of a vacuum sealed or lined locket. Opening the container will trigger the influx of air creating an audible sound and/or expose a color or texture changing material, lining the interior of the container, to an event or circumstance that initiates a change of color or texture.

### FIELD OF THE INVENTION

The invention is in the general field of lockets and more specifically lockets which contain a vacuum, crystals, or other mediums of capture.

### BACKGROUND OF THE INVENTION

Lockets of various shapes which open and close to display photographs are well known in prior art. Also well known in prior art are packages, cans, containers, that contain a vacuum to keep contents fresh/protected until the container is opened. Also known in prior art are devices that create vacuums for the purpose of channeling substances or items into a container such as wet/dry vacs, such substances or items to be disposed of at a later time. Also known in prior art is the employment of magnetic and other fields to record information.

### SUMMARY OF THE INVENTION

The invention is a flask or locket that may be opened to capture air or odor or any substance, item, or vapor that may be captured by means of vacuum and/or that may employ crystals to capture any force or field or emanation crystals are known to capture. Air or vapor or light or sound sensitive material that is known to change color or texture or size may be used as a lining of the locket or flask to denote the capture has been completed. The invention may be attached to a necklace, bracelet, or may be an intrinsic or added part of any shaped container of any sort such as a small treasure chest. The purpose of the invention is to capture and retain environmental and/or metaphysical properties that are present at life events such as a marriage proposal or child's first ball game, etc. Another purpose of the invention is to provide evidence that an initial opening of a closed container or locket has occurred; the evidence being a permanent and identifiable change in color or texture or other property of a lining or coating or material intrinsically a part of or attached to the container or of an object contained a part of or contained within the container.

### BRIEF DESCRIPTION OF THE DRAWINGS

FIG. 1 is a view of an open heart-shaped locket having a recessed area lined with an appearance changing coating or lining and having a crystal or other recording element positioned within the recessed area.

FIG. 1A is a view of a baseball shaped locket or container

FIG. 2 is a view of a heart-shaped locket illustrating the use of magnets as a method of holding the locket in a closed position

FIG. 2A is a view of a heart-shaped locket illustrating the use of a protruding seal 10A that fits into a receiving channel 10

FIG. 3 is a view of a baseball-shaped locket having an area that changes appearance once the locket has been opened.

FIG. 3A is a view of a baseball-shaped locket having an area that has changed appearance, the change having been triggered by the opening of the locket.

### DESCRIPTION OF AN EMBODIMENT

### Crystals or Capturing Elements

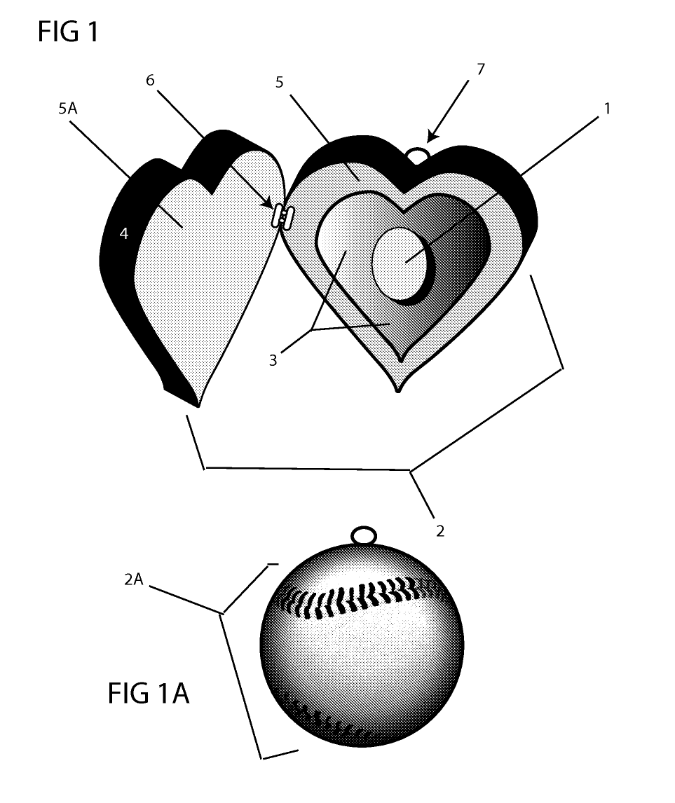

Referring to (FIG. 1) there is illustrated a Crystal 1. (FIG. 1) is intended to represent a crystal or any other material known to be affected by, or to capture; magnetic fields, light spectrums, sound or other energy emanations, atmospheric elements such as air and moisture, and/or any metaphysical property already known to be recordable or verifiable. For the purpose of this Specification, the phrase: “other material” shall be defined as described above. Crystals or “other materials” need not have any action performed on them to serve as capturing methods for the purpose of this invention because they are known to have intrinsic “capturing” properties, however, the following actions may be performed to achieve an altered and/or affected state of the crystal and may serve to affect or prepare a crystal for event recording. These actions will be termed: “first alignments” of a crystal or other material although other alignments may have already occurred.

The Crystal or “other material” may be magnetically affected or aligned by exposure to magnetic fields.

The Crystal or “other material” may be exposed to certain sound or light frequencies known to affect or eliminate the presence of matter or energy. For the purpose of the present invention this, too, will be termed a “first alignment”.

The Crystal or “other material” may be prayed over. The Bible and human experience are replete with examples of the power of prayer to affect or change both matter, energy, and circumstance. Jesus simply spoke the words: “Lazarus come forth” and every cell of the formerly dead friend of Christ came alive. In the Gospel of John, Jesus said: “The flesh (the words and desires of the human heart apart from God) accomplish nothing of eternal value but the words that I speak to you are spirit and are eternal life”.

The Book of Acts records that the Apostle Paul so emanated the Holy Spirit that pieces of his clothing retained the presence of the Holy Spirit and could be sent to someone who was ill or blind and the person would be healed if they touched the cloth with faith in Christ. Prayer is known to release the presence of God's Spirit in our lives and in our surroundings and Paul's clothes were exposed to much prayer and fasting on the part of the Apostle.

In Exodus Chapter 34 the Bible records that after Moses was in the presence of God, his face radiated with light. James 1:17 records that God is the Father, or Creator of Light. The more we uncover about the measurable properties of physical reality that we can perceive the more convincing is the supposition that, as many quantum physicists now conclude: our present reality is akin to an electrically based holographic image designed by an intelligent being. All of creation emanates magnetic fields and light fields that affect each other.

Referring to (Exibit 1), we have learned that colors of light can bring to a standstill certain brain activity or can “re-tune” corrupted neural patterns to their normal pattern, and can even shut down harmful bacteria's ability to emanate energy or matter that harms other organisms.

Research has also revealed that different magnetic patterns as well as light “auras” of varying colors are emanated that correspond to emotions being felt or thoughts being thought by an individual.

Praying over the Crystal, especially quoting words of scripture which Jesus states are filled with light and life, can bathe the Crystal with lights or fields that disassociate it from or purge it from any negative presence or energy present within or around it. Any “moment” subsequently captured would be captured in a medium (crystal) that had no corrupting matter or energy to affect the moment. For the purpose of this Specification “moment” may have as a definition: “Any event or circumstance or happening that generates magnetic, light, or metaphysical fields.”

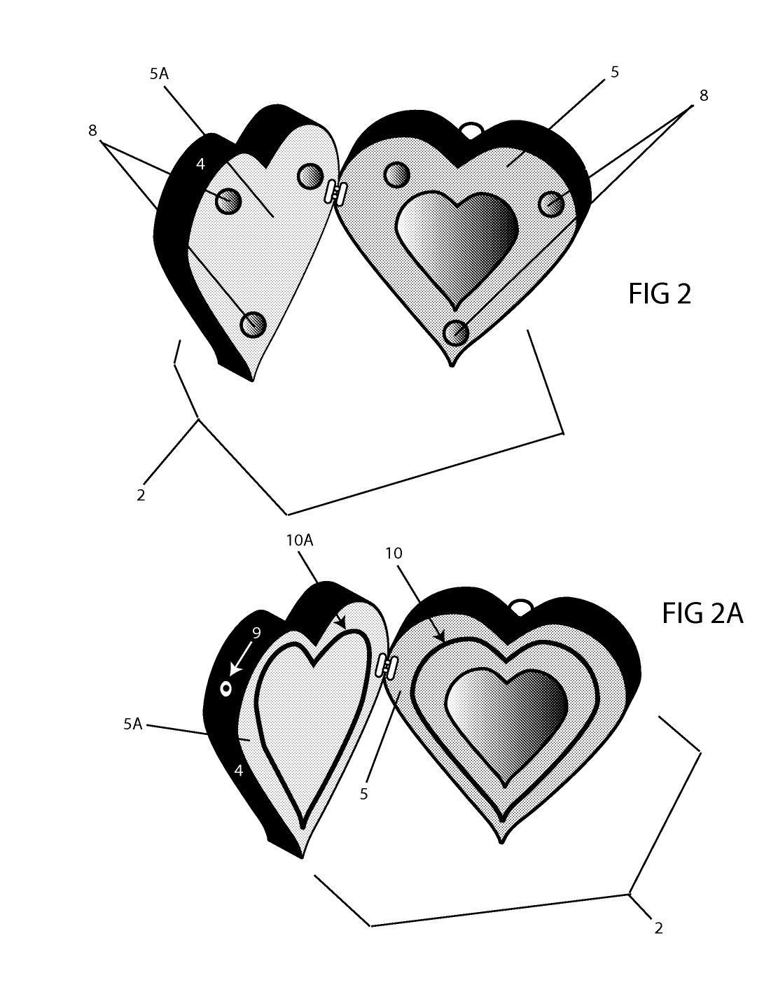

A simple evidence of being able to capture the energy generated by a moment or circumstance is “sunburn”. The radiated light left evidence of it's presence in the burnt or tanned skin; the medium of capture was the individual's skin. In this particular instance the burnt or tanned skin. In instances such as these, a memory of an incident can be “remembered” by the reaction of the capturing medium to the field of a particular energy being captured. Referring to (FIG. 2), inner lining material of the moment 5 and 5A may be of a material or coated with a material that reacts to light, sound, and/or other energy or elements and exhibits a change in it's appearance or structure after exposure to the moment upon opening of the locket. In addition to possible elements or fields of energy being captured by the react-able material, this occurrence also serves as a memory trigger.

Another simple evidence of a captured moment being achievable is the ability of recording equipment to “pull” the faint reverberations of a conversation out of the walls of a room long after a conversation took place. In the present invention, the crystal as a capturing medium captures moments in a similar manner.

Referring to (FIG. 1) 1, a locket will be opened at the moment intended to be remembered or captured occurs. In the embodiment shown in (FIG. 1), the crystal 1 present in a recessed area 3 present in the inside of the locket and is exposed to any light, sound, or other energy or matter occurring. The locket is then closed and the moment or energy and metaphysical fields present at the occurrence of the moment remain captured within the crystal. For the purpose of the present invention this is termed a “raw” capture.

In this simplest method of capture utilizing a simple ordinary locket and a contained crystal there may not be a prevention of subsequent energy fields being captured. However, just as a simple DVD disk is capable of recording vast amounts of “moments”, so too the crystal may still retain the intended moment to be captured and may one day be able to be retrieved and listened to or visually projected as technology advances. At present and in lieu of such technology, the actions engaged in, emotions felt and events witnessed by the individuals capturing the moment and/or participating in the moment, as well as opening the locket and/or by praying before or after the moment of capture will cause the crystal to become a memory trigger of that moment for all who participated: The crystal itself captures the moment as well as crystallizing the moment of capture as a recorded and trigger-able memory in the incredible recording medium of the human mind and spirit.

The present invention may utilize elements that naturally change in appearance or form or shape or structure due to intrinsic properties or due to coatings applied. Additionally, the present invention may utilize known procedures that cause such change.

Additionally, lockets or flasks that contain a vacuum may be employed to “capture the moment”: capturing any air or vapor or odor present at the moment of capture. The sound of in-rushing air or air or other-factor sensitive coatings or linings that change color or texture or size may be employed to signify the capturing vacuum has been triggered.

The present invention may also employ a method or device that emits light or sound when a locket or flask or other capturing container that houses the crystal or a vacuum is opened.

### The Container

(FIG. 1A) illustrates that the locket may be representative of the circumstances present at the time of capture. For instance, a child's first baseball or softball game experience could be captured in a baseball or softball locket.

It isn't necessary that a locket be a container; the container could be of any shape, design, material or element commonly used to contain.

Referring to (FIG. 2) preserving the crystal's “clean” state (no undesired energy fields present within the crystal) until the moment of capture may be accomplished by use of magnets 8 embedded within the inner lining 5 and 5A. In much the same way as a cell phone signal is “dropped” or dies out when passing under the strong magnetic fields generated by electrical power lines, the magnets generate a magnetic field. This field is strongest in the present invention when the locket 2 is closed and opposing magnets contact one another. When the locket is opened, the field may be weak enough to allow other fields to be captured, not repelled.

Referring to (FIG. 2A) a protruding seal or gasket 10A is illustrated that inserts into a recessed area 10 of the locket. The material used for the gasket 10A or that may lined recessed area 10 may be of material that changes color when the locket is opened or may be themselves of energy field recording material such as crystal.

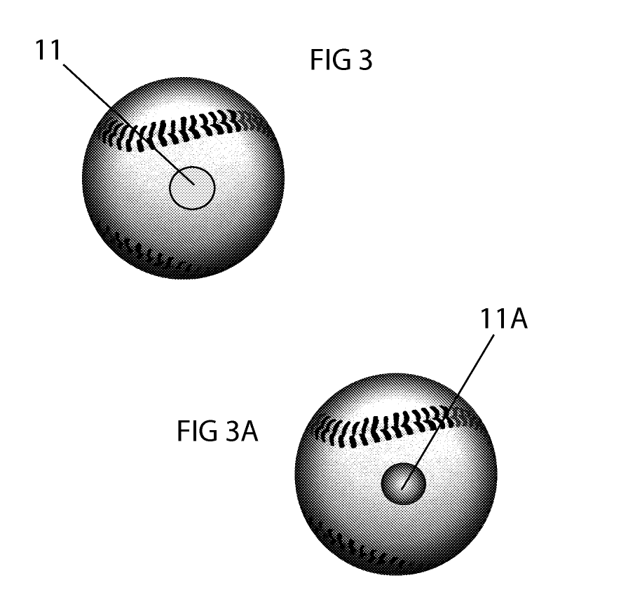

Referring to (FIG. 3) It is illustrated that an element 11 present on or embedded within on the outer shell of a locket 2A may change in appearance after a moment has been captured as is shown in (FIG. 3A)

11A. The element may extend through the shell into and through the inner lining of the locket on the inside just breaking it's surface or just beneath it. That lower most part of the element may be of a material or design that causes the top of the element seen on the outer shell to change in appearance after the locket is opened for the first time. All appearance changing components of the present invention may also exhibit this “first time” feature and the change that occurs may or may not be permanent.

Other appearance changing components in or on a locket may be utilized. For example: in the Baseball locket, the seams of the baseball may change in appearance. More than one appearance changing component may be utilized and possibly one element may intrinsically change on first exposure while another appearance changing element may be designed to not change until a second or third opening of the locket by means of coatings that peel or naturally dissipate over time or dissipate because of contact with human skin.

### Other Proof of Capture

The present invention may utilize and include as part of the invention, in addition to the above described appearance or property changing occurrences, any energy or matter measuring devices such as CT scanners, light or sound or other energy measuring devices, or any measuring or detecting device presently known or yet to be invented to either verify or hear or project or in other ways make known the capturing of some element or material or field present at a moment of capture; especially any element or material or field generated by the moment being captured.

### REFERENCE NUMERALS

1. Cyrstal, magnet, or other Capturing element
2. Heart shaped locket
2A. Baseball shaped locket
3. recessed area
4. outer surface of locket
5. inner lining, coating, or surface of locket
5A. alternate inner lining, coating, or surface of locket
6. Locket hinge
7. Attaching loop
8. magnets
9. vacuum or air valve
10. recessed area of seal
11. outer area or element that changes appearance or form or structure
11A. outer area or element that has changed appearance or form or structure

1. I claim as my invention a container having a lining or coating or object or device intrinsically a part of the container or adjacent to or contained within the container that permanently changes in appearance upon an initial opening of the container.

2. The invention according to claim One being a shaped locket.

3. The invention according to claim One being a flask.

4. The invention according to claim One containing a crystal or fluid other physical or metaphysical field recording substance, mixture, material, object, or device.

5. I claim as my invention a container containing a crystal or object or fluid that has been exposed to white light, or to a light spectrum known to cause neural brain patterns to normalize, before insertion into the container.

6. I claim as my invention a vacuum sealed container having a separate object or fluid within that permanently remains within the container after the negative air pressure within the container has equalized with surrounding atmospheric pressure.
